(19) United States
(12) Patent Application Publication
(10) Pub. No.: US 2025/0334290 A1
(43) Pub. Date: Oct. 30, 2025

(54) AIR CONDITIONING AND HEATING MANAGEMENT DEVICE, SYSTEM AND METHOD FOR LARGE BUILDINGS BASED ON ARTIFICIAL INTELLIGENCE

(71) Applicant: Korea Institute of Energy Research, Daejeon (KR)

(72) Inventors: Gwang Woo HAN, Daejeon (KR); Hak Geun Jeong, Daejeon (KR); Jong Hun Kim, Daejeon (KR); Seung Hwan Yoo, Daejeon (KR); Ha Neul Choi, Daejeon (KR); Byeong Mo Seo, Daejeon (KR); Seol Yee Han, Daejeon (KR); Sung Jin Lee, Daejeon (KR)

(73) Assignee: Korea Institute of Energy Research, Daejeon (KR)

(21) Appl. No.: 19/193,663

(22) Filed: Apr. 29, 2025

(30) Foreign Application Priority Data
Apr. 30, 2024 (KR) 10-2024-0057646

(51) Int. Cl. F24F 11/46; F24F 11/64

(52) U.S. Cl. CPC F24F 11/46; F24F 11/64

(57) ABSTRACT

According to an embodiment of the present disclosure, there is provided an air conditioning and heating management device for large buildings, the device including: a data collection unit including a first data hub that collects information fed from machinery and a second data hub that collects API (Application Programming Interface) integration information; and a prediction and set value extraction unit that derives management setpoint values by analyzing energy consumption in the building and making demand predictions, based on the data collected by the data collection unit, by utilizing an artificial neural network.

### CROSS REFERENCE TO RELATED APPLICATION

This application claims the benefit of and priority to Korea Patent Application No. 10-2024-0057646, filed on Apr. 30, 2024, the entire disclosure(s) of which is hereby incorporated herein by reference in its entirety.

### FIELD OF TECHNOLOGY

The present disclosure relates to an air conditioning and heating management device, system, and method for large buildings, that incorporate artificial intelligence to perform efficient management of air conditioning and heating in large buildings. A technology for air conditioning and heating for buildings described herein may include a technology for heating, ventilation, and air conditioning (HVAC).

### BACKGROUND

Large buildings typically operate energy-intensive systems, necessitating efficient energy management. However, conventional energy management systems in such buildings fail to adapt to dynamic changes in energy demand and environmental conditions, resulting in significant inefficiencies.

Specifically, conventional large building energy management systems have an air conditioning and heating system running on fixed schedules and preset temperature settings, which may be significantly different from actual demand. For example, fluctuations in demand can arise due to varying occupancy, outdoor weather changes, special events, etc., and the conventional large building energy management systems often fail to adapt to these fluctuations.

Moreover, the conventional large building energy management systems have little capability to flexibly adapt to minute environmental changes. For example, the energy management systems may not adjust properly to shifts in factors like variations in indoor or outdoor temperature, humidity, etc., which can lead to waste of energy.

Furthermore, the conventional large building energy management systems have very limited capacity for collecting and analyzing data. Notably, these systems underutilize data when it comes to analyzing data collected in real time to predict future demand or determine the optimal approach for operation.

In addition, most traditional large building energy management systems depend on active human intervention. For example, system monitoring and adjustments require manual input by building managers or administrators, thus creating inefficiencies and slowing down the response time of the system.

Accordingly, there arises an increasing demand for technologies that make predictions for energy management through state estimation by utilizing real-time collected data, estimate optimal setpoints based on the predictions and other information, and are capable of proactive energy management based on control set values derived from these estimates.

### SUMMARY

Against this background, an aspect of the present disclosure provides an air conditioning and heating management device and system for large buildings, capable of performing efficient management of air conditioning and heating in large buildings by utilizing real-time data based on artificial intelligence.

Furthermore, the present disclosure provides an air conditioning and heating management method for large buildings, capable of collecting data in real time and controlling each control system through a deep learning prediction model based on the real-time collected data.

To accomplish the aforementioned aspects, an embodiment of the present disclosure provides an air conditioning and heating management device for large buildings, the device including: a data collection unit including a first data hub that collects information collected from machinery and a second data hub that collects API (Application Programming Interface) integration information; and a prediction and set value extraction unit that derives management setpoint values by analyzing energy consumption in the building and making demand predictions, based on the data collected by the data collection unit, by utilizing an artificial neural network.

The large building may be a building with a total floor area of 10,000 m2 or above.

The machinery may include at least one of a BAS (building automation system), a solar inverter, a gas flow meter, a calorimeter, and an electricity meter.

The API integration information may include at least one of environmental information, occupant inference information, and building information.

The environmental information may include at least one of temperature information, humidity information, solar irradiation information, wind speed information, and air pollution information.

The data collection unit may include a main data server that collects data and sends the data to the prediction and set value extraction unit and a backup server for database duplexing.

The prediction and set value extraction unit may include: a deep learning prediction module that analyzes current state by using data transmitted from the data collection unit as input variables and predicts future state; and a reinforcement learning control module that derives set values by taking into consideration setting ranges and priorities of the management setpoints, based on state values resulting from the analysis by the deep learning prediction module.

The deep learning prediction module may analyze current state based on at least one of an air conditioning and heating demand profile, a renewable energy generation profile, a heat storage system's heat storage state, indoor thermal comfort calculation values, demand response signals, indoor occupant estimation values, and timestamp information and predict future state.

The setting ranges of the management setpoints may include a setting range of at least one of a cooling/heating setpoint for an absorption-type water cooler/heater, a heat storage temperature setpoint for a cooling and heating storage tank, a heat storage temperature setpoint for a hot water storage tank, an indoor temperature setpoint for an AHU (air handling unit), and an indoor temperature setpoint for an FCU (fan coil unit).

Another embodiment of the present disclosure provides an air conditioning and heating management system for large buildings, the system including: an air conditioning and heating management device including a data collection unit that collects information fed from machinery and API (Application Programming Interface) integration information and a prediction and set value extraction unit that derives management setpoint values based on the above data, by utilizing an artificial neural network; and a control module that transmits the management setpoint values to a BAS (building automation system) to control individual pieces of equipment.

The individual pieces of equipment may include at least one of an AHU (air handling unit), a gas absorption chiller-heater, a high-capacity heat pump, a thermal storage tank, a boiler, a hot water tank, an electric heat pump, and a FCU (fan coil unit).

A setpoint for controlling the AHU may include at least one of an air conditioning/heating temperature setpoint, a damper setpoint, a humidification setpoint, a warm-up setpoint, an enthalpy setpoint, and a freeze protection setpoint, a setpoint for controlling the gas absorption chiller-heater includes at least one of a supply temperature setpoint and a cooling/heating mode setpoint, a setpoint for controlling the high-capacity heat pump includes at least one of a thermal storage tank's heat storage temperature setpoint and a cooling/heating mode setpoint, a setpoint for controlling the thermal storage tank includes an air conditioning/heating temperature setpoint, a setpoint for controlling the boiler includes a hot water tank's heat storage temperature setpoint, a setpoint for controlling the hot water tank includes a hot water supply temperature setpoint, a setpoint for controlling the electric heat pump includes a cooling/heating mode setpoint, and a setpoint for controlling the FCU (fan coil unit) includes at least one of an indoor temperature setpoint, an operation mode setpoint, and an airflow setpoint.

Yet another embodiment of the present disclosure provides an air conditioning and heating management method for large buildings, the method including: a data collecting step in which information fed from machinery and API (Application Programming Interface) integration information are collected; a prediction and set value extraction step in which management setpoint values are derived by analyzing energy consumption in the building and making demand predictions, based on the data collected in the data collection step, by utilizing an artificial neural network; and a control step in which the management setpoint values are transmitted to a BAS (building automation system) to control individual pieces of equipment.

The prediction and set value extraction step may include: a state estimation step in which current state is analyzed by using the data collected in the data collection step as input variables and future state is predicted; a rule setting step in which setting ranges and priorities of the management setpoints for the large building are specified; and a setpoint estimation step in which setpoint values are derived by taking into consideration the current state analyzed in the state estimation step and the setting ranges and priorities specified in the rule setting step.

The control step may include: a signal transmission step in which the management setpoint values derived in the prediction and set value extraction step are transmitted to a BAS (building automation system); and a system control step in which individual pieces of equipment including at least one of an AHU (air handling unit), a gas absorption chiller-heater, a high-capacity heat pump, a thermal storage tank, a boiler, a hot water tank, an electric heat pump, and a FCU (fan coil unit) are controlled.

As described above, according to the present disclosure, it is possible to provide an air conditioning and heating management device and system for large buildings, that make predictions for energy management through state estimation by utilizing real-time collected data, estimate optimal setpoints based on the predictions and other information, and are capable of efficient energy management based on control set values derived from these estimates.

Furthermore, it is possible to provide an air conditioning and heating management method for large buildings, capable of controlling each control system through a deep learning prediction model based on real-time collected data.

Technical aspects to be accomplished by the disclosure are not limited to the above-mentioned technical aspects, and other technical aspects not mentioned herein will be clearly understood from the following description by those skilled in the art to which the disclosure pertains.

### BRIEF DESCRIPTION OF THE DRAWINGS

FIG. 1 is a schematic diagram showing an air conditioning and heating management device for large buildings according to an embodiment.

FIG. 2 is a schematic diagram showing a data collection unit.

FIG. 3 is a schematic diagram showing a prediction and set value extraction unit.

FIG. 4 is a schematic diagram showing an interaction between collected data and the prediction and set value extraction unit.

FIG. 5 is a schematic diagram showing an interaction between an external server and the prediction and set value extraction unit.

FIG. 6 is a schematic diagram showing an air conditioning and heating management system for large buildings according to an embodiment.

FIG. 7 is a flowchart showing an air conditioning and heating management method for large buildings according to an embodiment.

FIG. 8 is a flowchart detailing the prediction and set value extraction step.

FIG. 9 is a flowchart detailing the control step.

### DETAILED DESCRIPTION

Hereinafter, some embodiments of the present disclosure are described in detail with reference to the accompanying drawings. With regard to the reference numerals of the components of the respective drawings, it should be noted that the same reference numerals are assigned to the same components even when the components are shown in different drawings. In addition, in describing the present disclosure, detailed descriptions of well-known configurations or functions have been omitted in order to not obscure the gist of the present disclosure.

In addition, terms such as “1st”, “2nd”, “A”, “B”, “(a)”, “(b)”, or the like may be used in describing the components of the present disclosure. These terms are intended only for distinguishing a corresponding component from other components, and the nature, order, or sequence of the corresponding component is not limited to the terms. In the case where a component is described as being “coupled”, “combined”, or “connected” to another component, it should be understood that the corresponding component may be directly coupled or connected to another component or that the corresponding component may also be “coupled”, “combined”, or “connected” to the component via another component provided therebetween.

Large buildings have a system running that consumes large amounts of energy, which makes it essential for them to have an efficient energy management system. However, conventional large building energy management systems have relied on very static system operations.

Conventional large building energy management systems lean towards air conditioning and heating systems that run on fixed schedules and preset temperature settings, which may be significantly different from actual demand. For example, fluctuations in demand can arise due to varying occupancy, outdoor weather changes, special events, etc., and these systems need adaptive and more intelligent operations to adapt to these fluctuations.

Moreover, the conventional large building energy management systems lack the capability to flexibly adapt to minute environmental changes. For example, the energy management systems may not adjust properly to shifts in factors like variations in indoor or outdoor temperature, humidity, etc., which can lead to waste of energy.

Furthermore, the conventional large building energy management systems have limited capacity for collecting and analyzing data. Notably, these systems underutilize data when it comes to analyzing data collected in real time to predict future demand or determine the optimal approach for operation.

In addition, traditional large building energy management systems depend largely on active human intervention. Due to this, system monitoring and adjustments require manual input by building managers or administrators, thus creating inefficiencies and significantly slowing down the response time of the system.

The present disclosure proposes a management system that is best optimized based on artificial intelligence, that utilizes real-time collected data in order to address the problems of large building energy management systems that adopt static operations.

That is, the present disclosure proposes a system that is specialized in automatically calculating building-level set values (for example, air conditioning/heating temperature setpoints of an air conditioner, damper setpoints, room temperature setpoints of an indoor unit), which have been manually controlled by humans. The system may operate by deriving high-level operational strategies for building management, rather than modifying the existing BAS or facility control logic itself.

An embodiment of the present disclosure provides an air conditioning and heating management device for large buildings, the device including: a data collection unit including a first data hub that collects information fed from machinery and a second data hub that collects API (Application Programming Interface) integration information; and a prediction and set value extraction unit that derives management setpoint values by analyzing energy consumption in the building and making demand predictions, based on the data collected by the data collection unit, by utilizing an artificial neural network.

Here, the large building may be a building with a total floor area of 10,000 m² or above.

A large building with a total floor area of 10,000 m² or above may deploy and run at least one of a high-capacity gas absorption chiller-heater, an electrical ground-source heat pump combined with a thermal storage tank, and an electric chiller combined with cooling thermal storage to cover 60% or more of the total cooling and heating capacity and deploy and run electric heat pumps (EHP) with capacities below 20 kW to cover the remaining capacity.

Such air conditioning and heating management systems in large buildings rely heavily on direct intervention and control from building managers. This dependency exists especially because there are areas where high energy efficiency can be achieved by direct intervention and control from building managers.

For example, significant energy saving can be achieved by setting proper temperatures for air conditioners and heaters, performing partial operation of the air conditioners and heaters, deploying low-power air conditioning and heating devices, performing proper operation of the air conditioners and heaters, visualizing areas where the air conditioners and heaters are operable, installing high-efficiency air conditioners and heaters, turning off lighting after use, performing patrols, replacing LEDs in lighting, installing human detecting sensors, installing a total heat exchanger, and so on.

It can be nearly impossible for only a few building managers to adjust a large number of control setpoints to match various conditions, especially in large buildings to achieve the goal of energy efficiency. Besides, in case of large buildings managed directly by building managers, these adjustments often rely on the empirical knowledge or experience of building managers . . . .

Since there are many parts where intervention from managers is needed, conventional large building energy management systems are mostly run with fixed settings for individual pieces of equipment. These fixed settings can lead to inefficient operation without being able to respond to various changes in energy demand patterns, occupant satisfaction, and so on.

In order to optimize such energy management systems in large buildings, the present disclosure provides an air conditioning and heating management technology that can be automatically optimized based on real-time data by utilizing artificial intelligence, to provide optimal settings for individual pieces of equipment in large buildings.

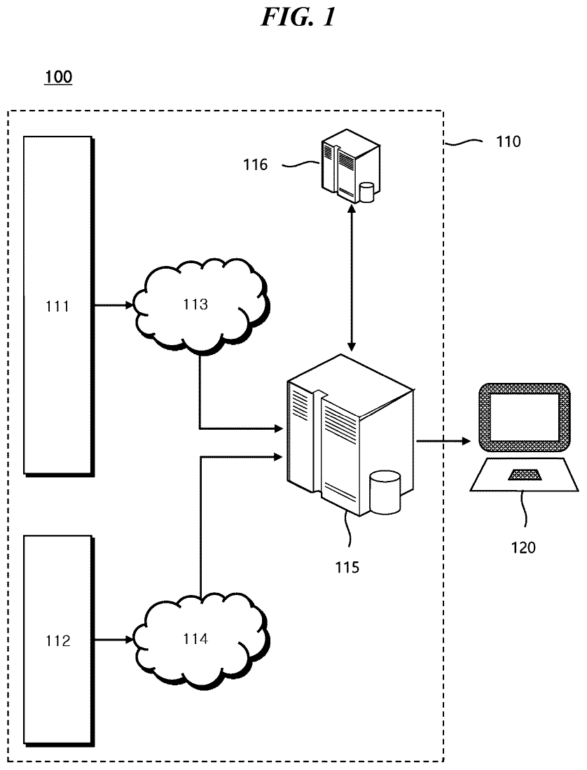

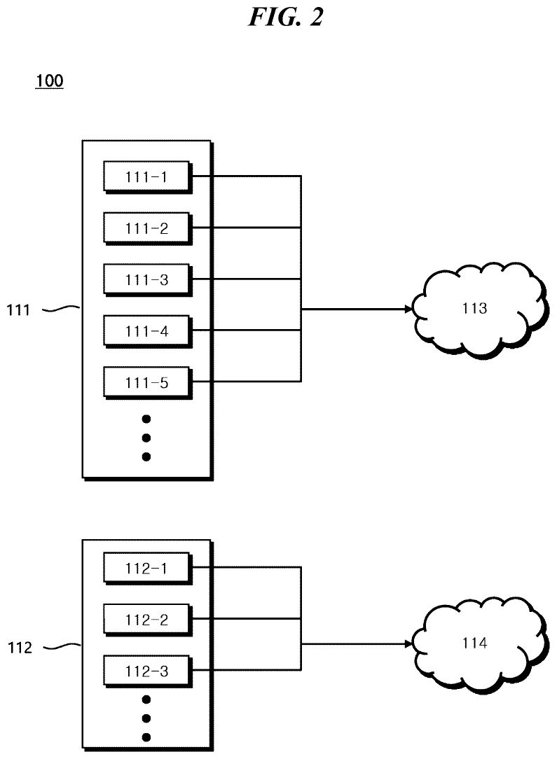

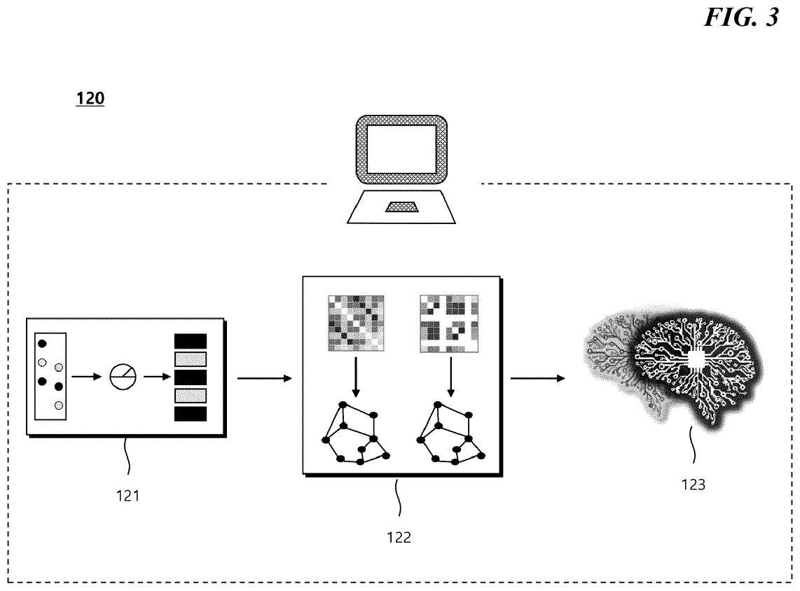

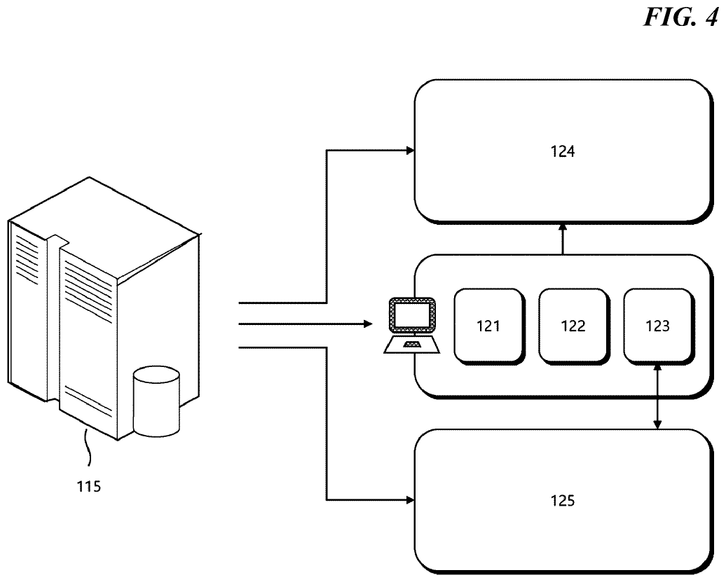

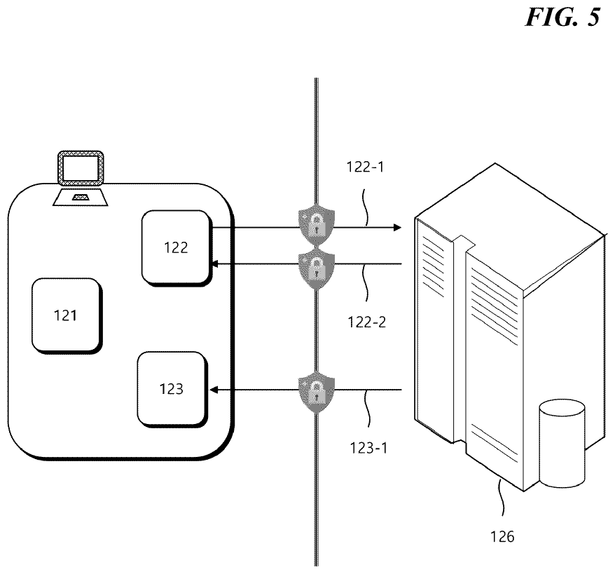

FIG. 1 is a schematic diagram showing an air conditioning and heating management device for large buildings according to an embodiment. FIG. 2 is a schematic diagram showing a data collection unit. FIG. 3 is a schematic diagram showing a prediction and set value extraction unit. FIG. 4 is a schematic diagram showing an interaction between collected data and the prediction and set value extraction unit. FIG. 5 is a schematic diagram showing an interaction between an external server and the prediction and set value extraction unit.

Referring to FIGS. 1 to 5, an air conditioning and heating management device 100 for large buildings according to an embodiment of the present disclosure may include a data collection unit 110 and a prediction and set value extraction unit 120.

The data collection unit 110 may include a first data hub 113 that collects information fed from machinery 111 and a second data hub 114 that collects API (Application Programming Interface) integration information 112.

The machinery 111 may include various pieces of equipment 111-1, 111-2, 111-3, 111-4, and 111-5 that provide information related to efficient air conditioning and heating in the large building. Specifically, the machinery 111 may include at least one of a BAS (building automation system), a solar inverter, a gas flow meter, a calorimeter, and an electricity meter.

The API integration information 112 may include an API system and databases 112-1, 112-2, and 112-3 that provide information about the inside and outside of the large building. Specifically, the API integration information may include at least one of environmental information, occupant inference information, and building information.

Here, the environmental information may include, but not limited to, at least one of temperature information, humidity information, insolation information, wind speed information, and air pollution information, and may further include information required for energy management in the large building.

Data thus collected may be sent to a main data server 115 via the first data hub 113 and the second data hub 114. The main data server 115 may send the received data to the prediction and set value extraction unit 120.

Meanwhile, the data collection unit 110 may include a backup server 116 for database duplexing in order to protect the data transmitted to the main data server 115.

An artificial neural network learning process may be performed through an active learning module 121, a deep learning prediction module 122, and a reinforcement learning control module 123.

The active learning module 121 may initialize a model by using unlabeled data and induce the model to select data that needs to be labeled, as a way of learning, thereby improving utilization of received data.

The deep learning prediction module 122 may learn and predict complex data patterns by utilizing a multi-layered neural network. The deep learning prediction module 122 may make predictions from input data it receives, extract features from the data by using a trained model, and identify patterns. The reinforcement learning control module 123 may maximize rewards by interacting with a digital twin environment 125. Consequently, the system is able to efficiently adapt to dynamic environments and make optimal decisions. That is, although the existing technologies generally adopt a manual operating method, according to the present disclosure, the system may optimize itself by performing automatic repetitive learning based on real-time data and the digital twin environment.

In the present disclosure, the active learning module 121 may train a deep learning prediction model for the deep learning prediction module 122 in a software-wise manner through a GPU server and train a reinforcement learning model for control by the reinforcement learning control module 123.

Meanwhile, data received from the data collection unit 110 may be used as input variables by the prediction and set value extraction unit 120.

For example, BAS (building automation system), solar inverter, weather data, power grid operation information, occupant inference information, current time information, etc. may be included as input variables for the management of air conditioning and heating in large buildings.

Here, the occupant inference information may be obtained through elevator operation information, access tag information, vehicle entry/exit information, CCTV, etc.

The deep learning prediction module 122 may analyze current state by using the input variables and predict future state. The deep learning prediction module 122 may analyze the current state of a building based on an air conditioning and heating demand profile, a renewable energy generation profile, a heat storage system's heat storage state, indoor thermal comfort calculation values, demand response signals, indoor occupant estimation values, and date information.

Specifically, data received from the BAS (building automation system) may serve as input variables for the heat storage system's heat storage state and the indoor thermal comfort calculation values, data received from the solar inverter may serve as input variables for the renewable energy generation profile, the weather data may serve as input variables for the air conditioning demand profile, the renewable energy generation profile, and the indoor thermal comfort calculation values, the power grid operation information may serve as input variables for the demand response signals, the occupant inference information may serve as input variables for the indoor occupant estimation values, and the current time information may serve as input variables for the date information.

The reinforcement learning control module may derive output variables by taking into consideration setting ranges and priorities of the management setpoints based on the current information of the building, in order to optimize the management of air conditioning and heating in a large building.

Boundary conditions may be set for the setting ranges—for example, an air conditioning and heating setting range of an absorption-type water cooler/heater, a heat storage temperature setting range of a cooling and heating storage tank, a heat storage temperature setting range of a hot water storage tank, an indoor temperature setting range of an air handling unit (AHU), and an indoor temperature setting range of a fan coil unit (FCU). Also, priorities may be determined as a priority rule in regard to responses to various special events (functions, breakdowns, etc.), energy peak demand management, central supply efficient operation control, etc.

That is, according to the present disclosure, responses to various events, energy peak demand management, etc. may be possible by dynamically estimating setting ranges based on the priorities, rather than using a static control method according to the existing technologies.

Meanwhile, as an example, the absorption-type water cooler/heater may have a setting range from 7 to 12° C. in cooling mode and a setting range from 40 to 55° C. in heating mode, the cooling and heating storage tank may have a setting range from 7 to 12° C. in cooling mode and a setting range from 38 to 50° C. in heating mode, the hot water tank may have a setting range from 45 to 60° C. for all seasons, the indoor temperature of the AHU may have a setting range from 23 to 28° C. in cooling mode and a setting range from 20 to 25° C. in heating mode, the indoor temperature of the FCU may have a setting range from 23 to 28° C. in cooling mode and a setting range from 20 to 25° C. in heating mode.

The reinforcement learning control module may derive output variables for optimizing energy management in a large building, by taking the above setting ranges and the above priorities into consideration.

The deep learning prediction module 122 may send time-series data related to demand and power generation to an external server 126 and have the external server 126 perform version updates on a prediction algorithm. Also, the reinforcement learning control module 123 may have the external server 126 perform version updates on a control algorithm. Such an interaction with the external server 126 may be made through a security system.

Meanwhile, the term “prediction”, as used herein, refers to predicting all controllable aspects based on comprehensive information related to energy management in large buildings, as well as information on something specific.

Next, an air conditioning and heating management system for large buildings according to another embodiment of the present disclosure will be described in detail.

According to an embodiment of the present disclosure, there may be provided an air conditioning and heating management system for large buildings, the system including: an air conditioning and heating management device including a data collection unit that collects information fed from machinery and API (Application Programming Interface) integration information and a prediction and set value extraction unit that derives management setpoint values based on the above data, by utilizing an artificial neural network; and a control module that transmits the management setpoint values to a BAS (building automation system) to control individual pieces of equipment.

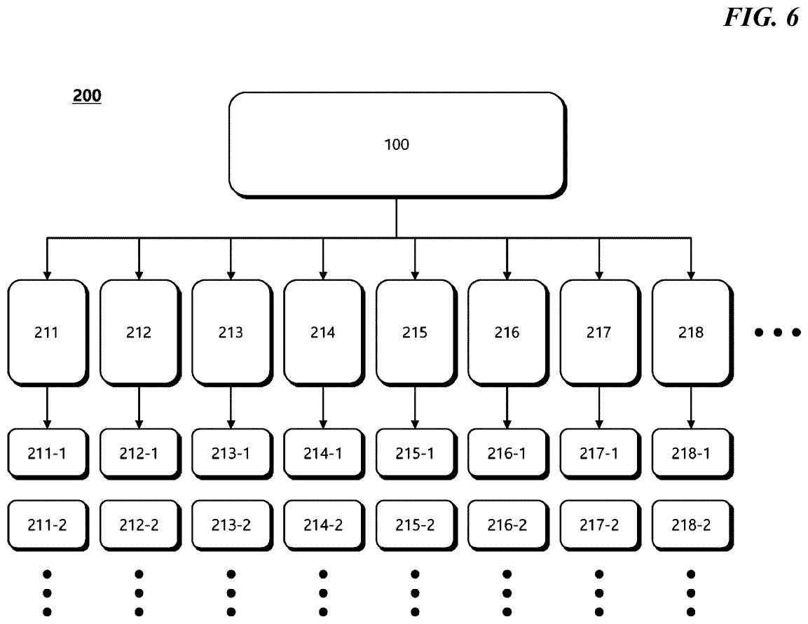

FIG. 6 is a schematic diagram showing an air conditioning and heating management system for large buildings according to an embodiment.

Referring to FIG. 6, the air conditioning and heating management system for large buildings may include an air conditioning and heating management device 100 and a control module (not shown).

The air conditioning and heating management device 100 may include a data collection unit 110 that collects information fed from machinery 111 and API (Application Programming Interface) integration information, and a prediction and set value extraction unit 120 that derives management setpoint values by utilizing an artificial neural network.

The management setpoint values derived from the air conditioning and heating management device 100 may be transmitted to the BAS (building automation system) to control individual pieces of equipment 211, 212, 213, 214, 215, 216, 217, and 218.

Since these individual pieces of equipment 211, 212, 213, 214, 215, 216, 217, and 218 may be controlled in different ways depending on the manufacturer, it may be difficult to control them collectively. Thus, the management setpoint values derived from the air conditioning and heating management device 100, which is a higher-order control system, may be transmitted to each control system to control the individual pieces of equipment 211, 212, 213, 214, 215, 216, 217, and 218.

Specifically, the individual pieces of equipment may include at least one of an AHU (air handling unit), a gas absorption chiller-heater, a high-capacity heat pump, a thermal storage tank, a boiler, a hot water tank, an electric heat pump, and a FCU (fan coil unit).

Here, a setpoint for controlling the AHU may include at least one of an air conditioning/heating temperature setpoint, a damper setpoint, a humidification setpoint, a warm-up setpoint, an enthalpy setpoint, and a freeze protection setpoint, a setpoint for controlling the gas absorption chiller-heater may include at least one of a supply temperature setpoint and a cooling/heating mode setpoint, a setpoint for controlling the high-capacity heat pump may include at least one of a thermal storage tank's heat storage temperature setpoint and a cooling/heating mode setpoint, a setpoint for controlling the thermal storage tank may include an air conditioning/heating temperature setpoint, a setpoint for controlling the boiler may include a hot water tank's heat storage temperature setpoint, a setpoint for controlling the hot water tank may include a hot water supply temperature setpoint, a setpoint for controlling the electric heat pump may include a cooling/heating mode setpoint, and a setpoint for controlling the FCU (fan coil unit) may include at least one of an indoor temperature setpoint, an operation mode setpoint, and an airflow setpoint.

Meanwhile, based on the received setpoints, the AHU may control a damper, an modulating valve, an supply fan/exhaust fan, a diffuser damper, etc., the gas absorption chiller-heater may control a circulation pump, an modulating valve, a water cooler/heater, a cooling tower, etc., the high-capacity heat pump may control a circulation pump, an modulating valve, a compressor, etc., the thermal storage tank may control a circulation pump, an modulating valve, etc., the boiler may control a circulation pump, an modulating valve, a burner, a heater, etc., the hot water tank may control a circulation pump, etc., the electric heat pump may control a compressor, etc., and the FCU may control a fan, a valve, etc.

Next, an air conditioning and heating management system for large buildings according to yet another embodiment of the present disclosure will be described in detail.

According to an embodiment of the present disclosure, there may be provided an air conditioning and heating management method for large buildings, including: a data collecting step in which information fed from machinery and API (Application Programming Interface) integration information are collected; a prediction and set value extraction step in which management setpoint values are derived by analyzing energy consumption in the building and making demand predictions, based on the data collected in the data collection step, by utilizing an artificial neural network; and a control step in which the management setpoint values are transmitted to a BAS (building automation system) to control individual pieces of equipment.

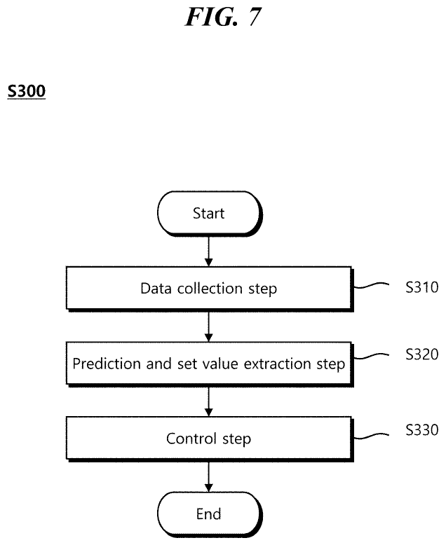

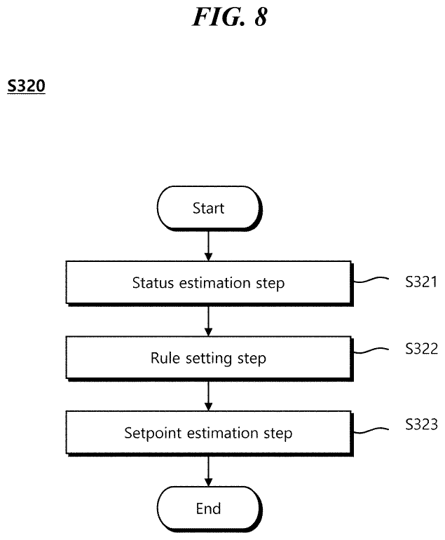

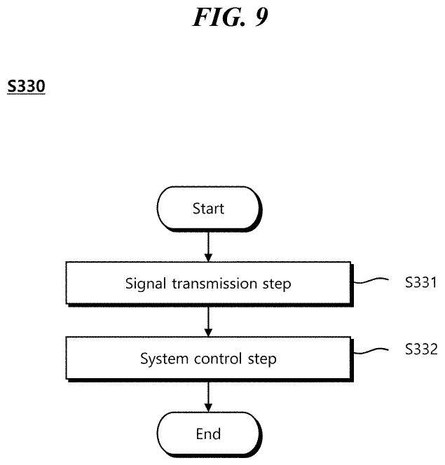

FIG. 7 is a flowchart showing an air conditioning and heating management method for large buildings according to an embodiment. FIG. 8 is a flowchart detailing the prediction and set value extraction step. FIG. 9 is a flowchart detailing the control step.

Referring to FIGS. 7 to 9, an air conditioning and heating management method S300 for large buildings according to an embodiment may include a data collection step S310, a prediction and set value extraction step S320, and a control step S330.

In the data collection step S310, information fed from machinery 111 and API integration information 112 may be collected.

In the prediction and set value extraction step S320, management setpoint values may be derived by analyzing energy consumption in the building and making demand predictions, based on the data collected in the data collection step S310, by utilizing an artificial neural network.

Specifically, the prediction and set value extraction step S320 may include a state estimation step S321, a rule setting step S322, and a setpoint estimation step S323.

In the state estimation step S321, current state may be analyzed by using the data collected in the data collection step S310 as input variables and future state may be predicted.

In the rule setting step S322, setting ranges of the management setpoints for the large building and the priorities of the management setpoints related to energy management in the large building may be specified.

In the setpoint estimation step S323, setpoint values may be derived by taking into consideration the current state analyzed in the state estimation step S321 and the setting ranges and priorities specified in the rule setting step S322.

The control step S330 may include a signal transmission step S331 and a system control step S332.

In the signal transmission step S331, the management setpoint values derived in the prediction and set value extraction step S320 may be transmitted to a BAS (building automation system).

In the system control step S332, individual pieces of equipment including at least one of an AHU (air handling unit), a gas absorption chiller-heater, a high-capacity heat pump, a thermal storage tank, a boiler, a hot water tank, an electric heat pump, and a FCU (fan coil unit) may be controlled.

Since terms such as “include,” “configure,” or “have” used above mean that relevant component may be included unless specifically stated otherwise, the terms should be construed as being able to further include other components, rather than excluding other components. All terms including technical or scientific terms have the same meaning as generally understood by those skilled in the art in the technical field to which the present disclosure pertains unless otherwise defined. Commonly used terms such as terms defined in a dictionary should be construed as having meanings consistent with meanings in the context of the related art, and should not be construed as idealized or overly formal meanings unless explicitly defined in the present disclosure.

The above description is merely an illustrative description of the technical idea of the present disclosure, and various modifications and variations can be made by those skilled in the art without departing from the essential characteristics of the present disclosure. Accordingly, the embodiments disclosed in the present disclosure are not intended to limit the technical idea of the present disclosure, but are for illustrative purposes, and the scope of the technical idea of the present disclosure is not limited by the embodiments. The scope of protection of the present disclosure should be construed according to the claims below, and all technical ideas within the equivalent scope should be construed as being included in the scope of rights of the present disclosure.

What is claimed is:

1. An air conditioning and heating management device for large buildings, the device comprising:
a data collection unit including a first data hub that collects information fed from machinery and a second data hub that collects API (Application Programming Interface) integration information; and
a prediction and set value extraction unit that derives management setpoint values by analyzing energy consumption in the building and making demand predictions, based on the data collected by the data collection unit, by utilizing an artificial neural network.

2. The air conditioning and heating management device of claim 1, wherein the large building is a building with a total floor area of 10,000 m² or above.

3. The air conditioning and heating management device of claim 1, wherein the machinery includes at least one of a BAS (building automation system), a solar inverter, a gas flow meter, a calorimeter, and an electricity meter.

4. The air conditioning and heating management device of claim 1, wherein the API integration information includes at least one of environmental information, occupant inference information, and building information.

5. The air conditioning and heating management device of claim 4, wherein the environmental information includes at least one of temperature information, humidity information, insolation information, wind speed information, and air pollution information, and the occupant inference information includes at least one of elevator operation information, access tag information, vehicle entry/exit information, or CCTV information.

6. The air conditioning and heating management device of claim 1, wherein the data collection unit includes a main data server that collects data and sends the data to the prediction and set value extraction unit and a backup server for database duplexing.

7. The air conditioning and heating management device of claim 1, wherein the prediction and set value extraction unit includes:
a deep learning prediction module that analyzes current state by using data transmitted from the data collection unit as input variables and predicts future state; and
a reinforcement learning control module that derives set values by taking into consideration setting ranges and priorities of the management setpoints, based on state values resulting from the analysis by the deep learning prediction module.

8. The air conditioning and heating management device of claim 7, wherein the deep learning prediction module analyzes current state based on at least one of an air conditioning and heating demand profile, a renewable energy generation profile, a heat storage system's heat storage state, indoor thermal comfort calculation values, demand response signals, indoor occupant estimation values, and date information, and predicts future.

9. The air conditioning and heating management device of claim 7, wherein the setting ranges of the management setpoints include a setting range of at least one of a cooling/heating setpoint for an absorption-type water cooler/heater, a heat storage temperature setpoint for a cooling and heating storage tank, a heat storage temperature setpoint for a hot water storage tank, an indoor temperature setpoint for an AHU (air handling unit), and an indoor temperature setpoint for an FCU (fan coil unit).

10. An air conditioning and heating management system for large buildings, the system comprising:
an air conditioning and heating management device including a data collection unit that collects information fed from machinery and API (Application Programming Interface) integration information and a prediction and set value extraction unit that derives management setpoint values based on the above data, by utilizing an artificial neural network; and
a control module that transmits the management setpoint values to a BAS (building automation system) to control individual pieces of equipment.

11. The air conditioning and heating management system of claim 10, wherein the individual pieces of equipment include at least one of an AHU (air handling unit), a gas absorption chiller-heater, a high-capacity heat pump, a thermal storage tank, a boiler, a hot water tank, an electric heat pump, and a FCU (fan coil unit).

12. The air conditioning and heating management system of claim 11, wherein a setpoint for controlling the AHU includes at least one of an air conditioning/heating temperature setpoint, a damper setpoint, a humidification setpoint, a warm-up setpoint, an enthalpy setpoint, and a freeze protection setpoint,
a setpoint for controlling the gas absorption chiller-heater includes at least one of a supply temperature setpoint and a cooling/heating mode setpoint,
a setpoint for controlling the high-capacity heat pump includes at least one of a thermal storage tank's heat storage temperature setpoint and a cooling/heating mode setpoint,
a setpoint for controlling the thermal storage tank includes an air conditioning/heating temperature setpoint,
a setpoint for controlling the boiler includes a hot water tank's heat storage temperature setpoint,
a setpoint for controlling the hot water tank includes a hot water supply temperature setpoint,
a setpoint for controlling the electric heat pump includes a cooling/heating mode setpoint, and
a setpoint for controlling the FCU (fan coil unit) includes at least one of an indoor temperature setpoint, an operation mode setpoint, and an airflow setpoint.

13. An air conditioning and heating management method for large buildings, the method comprising:
a data collecting step in which information fed from machinery and API (Application Programming Interface) integration information are collected;
a prediction and set value extraction step in which management setpoint values are derived by analyzing energy consumption in the building and making demand predictions, based on the data collected in the data collection step, by utilizing an artificial neural network; and
a control step in which the management setpoint values are transmitted to a BAS (building automation system) to control individual pieces of equipment.

14. The air conditioning and heating management method of claim 13, wherein the prediction and set value extraction step includes:
a state estimation step in which current state is analyzed by using the data collected in the data collection step as input variables, and future state is predicted;
a rule setting step in which setting ranges and priorities of the management setpoints for the large building are specified; and
a setpoint estimation step in which setpoint values are derived by taking into consideration the current state analyzed in the state estimation step and the setting ranges and priorities specified in the rule setting step.

15. The air conditioning and heating management method of claim 13, wherein the control step includes:
a signal transmission step in which the management setpoint values derived in the prediction and set value extraction step are transmitted to a BAS (building automation system); and
a system control step in which individual pieces of equipment including at least one of an AHU (air handling unit), a gas absorption chiller-heater, a high-capacity heat pump, a thermal storage tank, a boiler, a hot water tank, an electric heat pump, and a FCU (fan coil unit) are controlled.
